(19) United States
(12) Patent Application Publication
(10) Pub. No.: US 2008/0294519 A1
(43) Pub. Date: Nov. 27, 2008

(54) Method and system for integrating advertising with content

(76) Inventors: James Cameron Warwick, Chicago, IL (US); Trent Richard Nanke, Naperville, IL (US)

Correspondence Address: BRINKS HOFER GILSON & LIONE, P.O. BOX 10395, CHICAGO, IL, 60610, US

(21) Appl. No.: 11/805,930

(22) Filed: May 25, 2007

(51) Int. Cl. G06Q 30/00; G06Q 40/00

(52) U.S. Cl. 705/14; 705/37

(57) ABSTRACT

A coupling software system that is designed to be used by an advertiser, a content provider, and a publisher to effectively couple advertisements with content and distribute the information through a media outlet. The coupling software enables the advertiser to search content and distribution channels using a variety of metrics, and allows the advertiser to purchase content and distribution channels through an auction/bidding process. The coupling software is designed to measure and report statistics associated with the transactions between the advertisers, content providers, and publishers.

### FIELD OF THE INVENTION

The present invention relates generally to software. In particular, the invention relates to a network system that provides an interface between content providers, advertisers, and publishers to intergrate advertising with content.

### BACKGROUND OF THE INVENTION

The process of advertising involves three primary entities: the content provider, the advertiser, and the publisher. Available software enables these entities to interact with one another. However, the transactions between these entities are not harmonious, and often occur separately. For example, the transaction between the content provider and the advertiser is usually independent from the transaction between the content provider and the publisher. In this example, the content provider has the responsibility to choose a particular publisher to publish a particular advertisement with a selected content. Alternatively, the publisher may negotiate independent transactions between the content provider and advertiser, respectively.

In either of the aforementioned scenarios, the content provider, advertiser, and publisher do not communicate collectively. As a result, there are instances where the advertiser cannot target its advertisements toward an intended demographic or where the content provider and publisher do not receive the best value for their services. Moreover, it is difficult to gather and provide statistical information about advertisers, publishers, or content providers that could significantly improve the effectiveness of marketing campaigns.

### SUMMARY OF THE INVENTION

In accordance with the present invention, a network system is provided for coupling advertisements with content through the Internet by integrating component providers and publishers through an interface. In various embodiments, the interface provides searchability, intelligent matching of content with the advertisements and convenient billing and tracking capability.

In one aspect of the present invention, a network system is provided including an advertisement providing server, an advertisement terminal, a content providing server, a distribution server, a database server and an artificial intelligence module. The advertisement providing server is configured to store advertisement information, and content providing server is configured to store media content such as stories, news and entertainment. The content providing server is configured to store the media content, and a distribution server is configured to publish media content and advertisement information. A database server is provided in communication with the advertisement providing server, content providing server, and the distribution providing server, wherein the database server is configured to process and store information provided by the content providing server, the advertisement terminal, and the distributing terminal. An artificial intelligence module is also provided to process the information provided by the content terminal, the advertisement terminal, and the distributing terminal.

In another aspect of the invention, a network system is provided including an advertisement providing means, a content providing means, a distribution means, a database server and an artificial intelligence means. The advertisement providing means stores advertisement information, and the content providing means stores media content. The distribution means is capable of publishing the media content and advertisement information. The database server means is in communication with the advertisement providing means, content providing means, and the distribution means and the database server means processes and stores information provided by the content providing means. An artificial intelligence means is provided for processing the information provided by the content providing means, the advertisement providing means, and the distribution means. In another aspect of the invention, a method for distributing advertisements from an advertiser through a network is provided. The method includes reviewing criteria related to a selected advertisement, reviewing a content set of content items in the server using at least on a first search method, providing a set of selected content items from the content set based on a second search method, providing a set of suggested content items from the content set, coupling one or more of the selected and suggested content items with the selected advertisement to create a coupled content set, determining payment to be made by the advertiser for running the selected advertisement, notifying at least one publisher of the coupled content set for publication, and tracking the publication of the coupled content set by at least one of the publishers.

The various embodiments provide significant advantages over other advertisement software. For example and without limitation, the ability for content providers, advertisers, and publishers to communicate collectively in real-time reduces the amount of time required to publish a selected advertisement and content on a particular media outlet. By each entity using the same software interface, data and other statistical information can be easily gathered and evaluated to assist each entity to become more efficient. Finally, this software will allow an advertiser to select the content and decide where to publish the advertisement - options that current advertisement software programs do not allow.

The foregoing paragraphs have been provided by way of a general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a high-level diagram showing a general network configuration composed of content providers, advertisers, and publishers;

FIG. 2 is a flow diagram of an exemplary system in accordance with a first embodiment of the present invention;

FIG. 3 is a flow diagram of an exemplary method in accordance with a second embodiment of the present invention; and

FIG. 4 illustrates an exemplary view of a hierarchy of screen views and associated information in accordance with another aspect of the invention.

### DETAILED DESCRIPTION OF THE PRESENTLY PREFERRED EMBODIMENTS

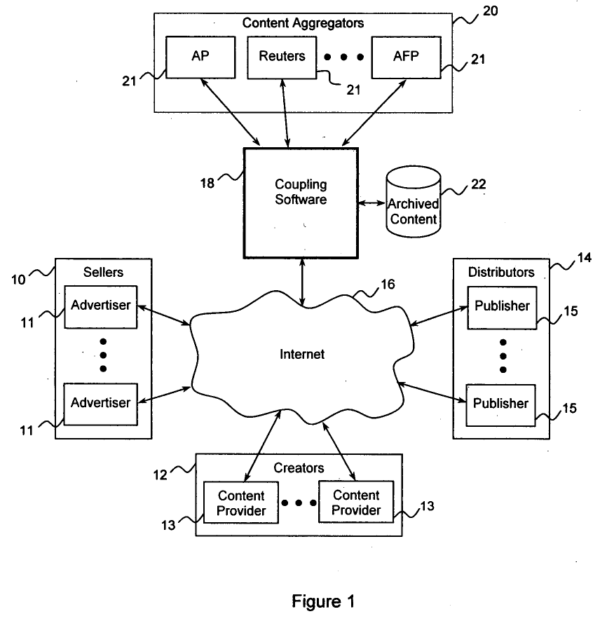

Referring to the drawings, FIG. 1 is a high-level diagram illustrating an advertising environment including an advertiser 10, a content provider 12, and a publisher 14. The advertiser 10 may consist of an advertisement entity or an individual seeking to couple advertisements with content. The content provider 12, similarly, may be a large content provider, supplying content in a range of different subjects, or may be an individual with limited content. For example, and without limitation, content may be text, audio, image, or video based. Moreover, the substance of the content may vary from mainstream news to personal blogs. The types of publishers 14 may range from, for example and without limitation, a nationally known television network to an independent website. Although each entity is described separately, it can be appreciated that more than one function may be performed by a single entity.

The advertiser 10, the content provider 12, and the publisher 14 are in communication with each other through the Internet 16. Alternatively, these entities may be in communication through a private, secure or internal networking interface (not shown). Also in communication through the internet 16 is a coupling software 18. The coupling software 18 may also be in communication with a content aggregator 20. The content aggregator 20 is similar to the content provider 12 in that the content aggregator 20 provides content to the coupling software 18. However, the content supplied by the content aggregator 20 may be gathered from a variety of sources such as news feeds, advance sheets, etc. Examples of content aggregators 20 include: the Associated Press, Reuters, and Agence-France Presse.

Also coupled to the coupling software 18 is an archived content database 22. The archived content database 22 stores content received from the content providers 12 or the content aggregators 20 for future use and recall.

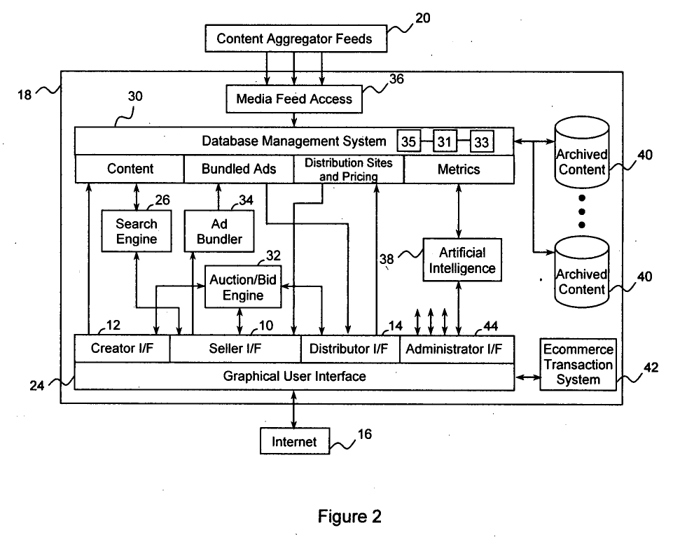

FIG. 2 is a high-level system drawing of the coupling software 18. The coupling software 18 includes a graphical user interface 24. The graphical user interface 24 is in communication with the advertiser 10, the content provider 12, the publisher 14, and an administrator 44 through a network such as the Internet 16.

The advertiser 10 will have access to the coupling software 18 via a unique login and password. The advertiser 10 communicates with the coupling software 18 through an advertisement providing server 11 and an advertisement terminal (not shown). The advertisement providing server 11 may correspond to an individual advertisement providing servers 11 or, in the alternative, may comprise groups of advertisement providing servers 11 that may communicate through a network or the Internet. The advertisement terminal is in communication with the advertising providing server and the coupling software. The coupling software 18 will allow the advertisers 10 to view a streaming list of real-time information including date and time stamp, content title, subject category, source, type of content (e.g. text, audio, image, video), duration or size of the content, available markets, demographics, and price. The advertiser 10 will be able to preview the content prior to making a final selection to purchase. Once the advertiser 10 has selected the content, the creative advertisement can be uploaded from a desktop (not shown) or a server (not shown), coupled with the content, and previewed. This is referred to herein as “bundled content” or a “coupled content set,” where at least one advertisement is coupled with at least one particular content. The coupling software 18 will allow the advertiser 10 to chose a market and media outlets based on demographic information. The advertiser 10 may be allowed to review pricing and ultimately make a media purchase to publish the bundled, or coupled, content and advertisement.

The content provider 12 will also have access to the coupling software 18 via a unique login and password. The content provider 12 is in communication with the coupling software 18 via a content providing server 13. The content providing server 13 may correspond to an individual content providers 13 or, in the alternative, may comprise groups of content providing servers 13 that may communicate through a network or the Internet. The content providing server is configured to store all of the content produced or gathered from the content provider 12. The content provider 12, when desired, will upload the content to the coupling software 18 for consideration by advertisers 10. The content providers 12 can respond to auction bids, review metrics associated with their content, and their activity and transaction statements.

The publisher 14 will have access to the coupling software 18 via a unique login and password. The coupling software 18 may be web-based or, in the alternative, may be run on a platform such as Microsoft windows. The publisher 14 is in communication with the coupling software 18 through a distribution server 15 at is configured to publish media content and advertisement information. The distribution server 15 is in communication with a database management system 30. The distribution server 15 may correspond to an individual distribution server 15 or, in the alternative, may comprise groups of distribution servers 15 that may communicate through a network or the Internet. The coupling software 18 will allow publishers 14 to manage their list of distribution sites, media types, and demographics. Third party verification of distribution media demographics will also be provided. The distributors 14 can respond to auction bids, and can review metrics associated with their media sales, their activity, and transaction statements.

The coupling software 18 further runs in conjunction with a database server 31 that is in communication with the advertisement providing server, content providing server, and the distribution providing server. The database server 31 may comprise a separate external hardware server, or a module running as part of the coupling software 18.

The database server 31 can process and store information provided by the content providing terminal, the advertisement providing terminal, and the distributing terminal. Moreover, the database server 31 is configured to perform searches of content from the content providing server 12. The database server 31 may also have a search engine for use by the advertisement provider 10 to search for content and distribution information. Additionally, the database server 31 may have a content notification system that may notify a content provider 12 that its content is being searched. Additionally, the database server 31 may also have a third party verification 33 system that verifies changes made to an user relative to the transaction.

The administrator 44 will also have access to the coupling software 18 through a unique login and password. The coupling software 18 will allow the administrator 44 access to and control over all components of this system as well as all user information. The coupling software 18 will also allow the administrator 44 the ability to generate customer, transaction, and system performance reports. The coupling software 18 will also provide customer on-line help and support services.

The graphical user interface 24 allows each entity to communicate with the coupling software 18. In communication with the graphical user interface 24 is an e-commerce transaction system 42. The e-commerce transaction system provides a mechanism to invoice and electronically bill appropriate users of the coupling program 18. Content providers' 12 accounts are credited for sales of content, the publishers' 14 accounts are credited for sales of distribution media, and the advertisers' 10 accounts are debited for purchases of content and/or distribution media. All users can access the current status of their transactions via a status report. Transactions are backed up on a database management system 30. In addition, a billing server 35 for tracking the publication of the coupled content set and arranging for payment of funds relative to the publication may be in communication with the database server or the coupling software 18.

The content provider 12 can upload content 28 into the coupling software 18 for advertisers 10 to view. The publisher 14 or content aggregator 20 also enters the distribution information and pricing into the coupling software 18. Advertisements that are coupled with content are also stored within the coupling software 18. The metrics involving transactions among the advertisers 10, content providers 12, and publishers 14 are stored within the coupling software 18. The content, bundled ads, distribution sites and pricing, and metrics are all part of the database management system 30 of the coupling software 18.

Specifically, the database management system 30 provides an archive for streaming content, storage capability for advertisements bundled with content, storage for distributor sites and pricing information, and storage for a variety of customer and system metrics. The streaming content is stored in an archived content component 40, which is in communication with the database management system 30. Also in communication with the database management system 30 is a media feed access component 36 that provides a high-speed interface between content aggregators 20 and the database management system 30.

The coupling software 18 further includes a search engine 26 which allows an advertiser 10 to search uploaded content. The search engine 26 is a primary component for the advertiser 10 to use when seeking appropriate content for its creative advertising. Advertisers 10 will be able to select content from content providers 12 through a key word search (including Boolean AND, OR, NOT), vertical subject areas (sports, business, health, etc.), geography (New York, Chicago, San Francisco, etc.), timeline (last hour, yesterday, last week, next week, etc.), source, or any combination of the above. The search engine 26 determines the target audience for specific type content, so advertisers 10 can couple ads with content directed towards a specific market. The search engine 26 will provide third-party verification of content by analysis of related content to verify relevance and ownership. The search engine 26 also provides third-party accounting and auditing by tracking content being searched and providing appropriate metrics. The search engine 26 also tracks content and advertising downloads and provides the associated metrics. The search engine 26 is also designed to eliminate click fraud and over counting through various conventionally available methods, but integrated into the present system. The search engine 26 is also designed to inform content providers 12 if their content is being searched and/or downloaded. The search engine 26 is also capable of searching and capturing future content when it is made available.

Also included in the coupling software 18 are an auction/bid engine 32 and a bundler program 34, which couples content and advertisements together. The auction/bid engine 32 provides the mechanism for the advertiser 10 to bid on certain types of content and distributions. A variety of methods may be supported by this engine 32. For example, and without limitation, one method that may be used is a Dutch auction, or “blind bidding.” The Dutch auction allows the advertiser 10 to bid without knowing the final price until it is accepted. Another feature is called preemptive bidding, which allows a higher bid to be accepted over a lower, first, bid. In preemptive bidding, the seller may also set a premium buy, which allows a bidder to agree to a set price, thereby closing the auction and preventing others to preempt the previous bid. The auction/bid engine 32 also allows sellers to bid manually, automatically, on a preemptive basis, or non-preemptive basis. It allows the highest bidder to receive access to the particular content or the right to distribute through the selected publisher 14. Content providers 12 decide the pricing for their content, whether it is a flat rate or if they want to allow a bidding process. Publishers 14 decide the pricing for their media distribution in a similar manner, and allow advertisers 12 to bid on particular media. Content and/or distribution either go to the highest bidder or will remain unsold.

The bundler program 34 allows the advertiser 10 to view or preview the bundled creative advertisement and content prior to publishing. The program 34 includes a variety of advertisement placement styles depending on the type of media. Examples of placement styles include: banner, pop-up, pop-under, skyscraper, streaming audio, streaming video, unicast superstitual, rectangular, lead-in, and lead-out.

An artificial intelligence component or module 38, is implemented in communication with the database management system 30 and measures the system and user metrics discussed above. In addition, the artificial intelligence component 38 also develops a suggested bidding range for advertisements and media outlets based on previous transactions. The artificial intelligence component 38 sets pricing based on usage, and it provides a reporting mechanism of a variety of metrics. Such metrics include, for example, high, low, and expected price points; inability of content providers and publishers to take orders, pulled orders, response time, ease of work with each entity; and account status of each entity. In addition, the artificial intelligence component 38 may also include a rating system (not shown) for consumers to evaluate the reliability of other advertisers 10, content providers 12, and publishers 14. The metrics gathered from the artificial intelligence component 38 may be used to notify an advertiser 10, content provider 12, or publisher 14 of particular pricing or opportunities that may be of interest. For example, the artificial intelligence component 38 may notify a particular advertiser 10 of an article on a topic that the particular advertiser 10 has bided in or purchased in the past. Similarly, the artificial intelligence component 38 may notify the advertiser 10 of a publishing outlet that the particular advertiser has chosen in the past. In sum, the artificial intelligence component 38 may “learn” individual trends or preferences of certain advertiser 10, content providers 12, or publishers 14, and be able to notify them of a particular opportunity. To this end, the artificial intelligence component 38 may be able to predict metrics, such as, pricing trends or demand of content, that may be used as economic indicators, and use conventional “intelligent” or deductive algorithms to accomplish these tasks.

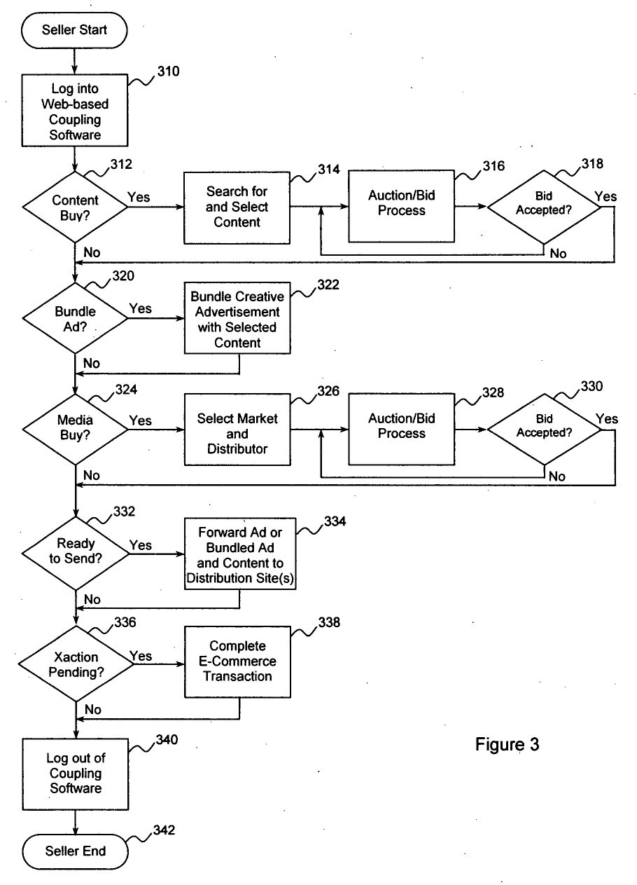

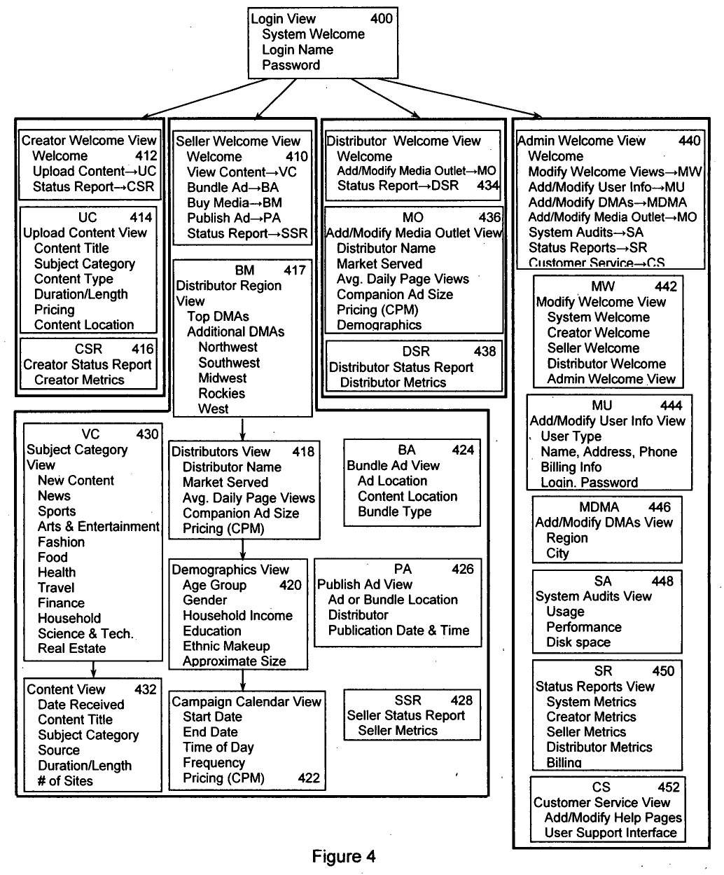

FIG. 3 is a flow diagram of an exemplary method of how an advertiser 10 would access and use the coupling system 18. First, the advertiser 10 would log into the coupling system 18 (Block 310) using a unique login and password. If the password and login are correct, a welcome screen with a high-level menu will appear so the advertiser 10 can choose which task to perform, as illustrated in Block 410 in FIG. 4.

Once the advertiser 10 has logged in to the coupling software 18, the advertiser 10 may select whether to purchase content (Block 312). There are two methods that the advertiser 10 can use to select content (Block 314). The first method requires the advertiser 10 to pick particular content as it streams through the coupling software 18. Each piece of content displays the date and time stamp, headline, subject category, source, type of content, duration or length, and number of available markets. By selecting the headline, the advertiser 10 will be able to view the content in its native medium (e.g. video, photo, audio, text). Similarly, by selecting the number of markets header, the advertiser 10 will be able to view the list of available markets. The second method allows the advertiser 10 to search for content by utilizing the search engine 26 component described above.

Once a particular content is selected, through manual or automatic means, the advertiser 10 must either bid on the content or purchase the content (Blocks 316 and 318). The purchasing process is facilitated by the e-commerce transaction system 42.

The next step gives the advertiser 10 the option to couple the advertisement with the selected content (Block 320). The coupling system 18 will allow the advertiser 10 to preview the final layout (Block 322).

Next, the advertiser 10 has the option to distribute the coupled advertisement and content (Block 324). The advertiser 10 can review and select the publisher geographic regions, followed by the specific publishers within that market (Block 326). The advertiser 10 is able view the statistics of each publisher 14 when making a selection. Once the publisher 14 is selected, the advertiser 10 can review their associated demographics and select the campaign dates for the advertisement. Similar to the purchase of content described above, if the publisher 14 is not priced at a flat rate, the advertiser 10 will have an opportunity to bid (Block 328) using the Auction/Bid engine 32. Once the advertiser 10 purchases, or places the winning bid of (Block 330), the transaction is completed by the e-commerce transaction system 42.

Once the publishing distribution is purchased or bypassed, the advertisement alone or the advertisement coupled with the content is ready to be sent (Block 332) to the publisher. The advertisement with or without the content can then be forwarded (Block 334) to the publisher for distribution.

The coupling software 18 then determines whether any other transactions are pending (Block 336), and if so, completes those transactions (Block 338). Finally, the advertiser 10 logs out of the coupling software 18 (Block 340 and 342), or alternatively, may restart the selection process to distribute another advertisement.

FIG. 4 is an exemplary hierarchy screen view of the coupling software 18. The creator welcome view (Block 412) allows the content provider 12 to upload content to the coupling software 18; specify characteristics of the content (e.g. content title, subject category, content type, duration/length, pricing, content location) (Block 414); or display and/or print a creator status report containing metrics (Block 416) associated with search and select activity of the content provider's (creator's) 12 content, and transactions associated with content sales.

The advertiser's welcome view (Block 410) allows an advertiser 10 to view, search for, and select content and preview it (Blocks 430 and 432); select a market and media outlet and buy media space (Blocks 417-422); forward an ad or bundled ad and content to the media outlet for publication (Blocks 424 and 426); and display and/or print a seller (advertiser) status report containing metrics associated with the seller activity and transactions associated with content and media buys (Block 428).

The distributor's welcome view (Block 434) allows a publisher (distributor) 14 to add or modify media outlet information (including, for example, distributor name, market served, average daily page views, companion ad size, and pricing, and demographic information) (Block 436). The publisher 14 can also display and/or print a distributor status report containing metrics associated with activity of the distributor's media sites, and transactions associated with media distribution sales (Block 438).

The administrator's welcome view (Block 440) allows a system administrator 44 to modify user welcome views (Block 442), user information (Block 444), demographic market areas (Block 446), and media outlet information (Block 440). The administrator's welcome view (Block 440) also allows the administrator 44 to run system audits (Block 448), maintenance routines, display and/or print a system status report that contains metrics associated with the system and/or specific users and billing transactions (Block 450), and access the system help and customer service interface (Block 452).

While the invention has been illustrated and described in detail in the drawings and foregoing description, the same is to be considered as illustrative and not restrictive in character, it being understood that only exemplary embodiments have been shown and described and do not limit the scope of the invention in any manner. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

What is claimed is:

1. A network system comprising:
an advertisement providing server configured to store advertisement information;
an advertisement terminal in communication with the advertisement providing server;
a content providing server configured to store media content;
a distribution server configured to publish media content and advertisement information;
a database server in communication with the advertisement providing server, content providing server, and the distribution providing server, wherein the database server is configured to process and store information provided by the content providing server, the advertisement terminal, and the distributing terminal; and
an artificial intelligence module in communication with the database server, the artificial intelligence module configured to assist the database server to process the information provided by the content terminal, the advertisement terminal, and the distributing terminal.

2. The network system of claim 1, wherein the database server further comprises a user interface to allow a user to access and manipulate the content, advertisements, and distributing information.

3. The network system of claim 2, wherein the database server further comprises a transaction system that tracks and compiles transactions made by the user.

4. The network system of claim 2, wherein the database server is in communication with a third party verification system to verify charges made to the user relative to the transactions.

5. The network system of claim 1 wherein the advertisement providing server, the content providing server and the database server are in communication with each other via the internet.

6. The network system of claim 1 wherein the database server is configured to perform searches of content from the content providing server.

7. The network system of claim 1, wherein the database server further comprises a search engine for use by an advertisement provider to search for content and distribution information.

8. The network system of claim 7, wherein the database server is configured to notify a content provider that its content on the content server is being searched.

9. The network system of claim 7, wherein the database server further comprises an auction server for conducting auctions of the content, receiving bids from bidders, and the distributing information for use by the advertisement provider.

10. The network system of claim 9, wherein the database server further comprises a bundler system to couple and preview the advertisements with content.

11. The network system of claim 10, wherein the database server further comprises a processor to store and process purchase and statistical information.

12. The network system of claim 11 wherein the database server compiles at least one profile specific to an advertisement, wherein the profile is based on the purchase and statistical information.

13. The network system of claim 11 wherein the database server couples content with at least one advertisement into a coupled content set, generates a preview of the coupled content set and verifies the accuracy of the coupled content set.

14. The network system of claim 11, wherein the database server further comprises a database management system that communicates with and stores information from the content providing terminal, the advertisement providing terminal, the bundler system, the distributing terminal, and the processor.

15. The network system of claim 13 wherein the distribution server distributes the at least one advertisement for distribution as a coupled content set to at least one publisher for publication of the coupled content set.

16. The network system of claim 13 further comprising a billing server in communication with the network, the billing server configured to track the publication of the coupled content set and arrange for payment of funds relative to the publication.

17. A method for distributing advertisements from an advertiser through a network having one or more servers, said method comprising:
Reviewing criteria related to a selected advertisement;
Reviewing a content set of content items in said server using at least on a first search method;
Providing a set of selected content items from said content set based on a second said search method;
Providing a set of suggested content items from said content set;
coupling one or more of said selected and suggested content items with said selected advertisement to create a coupled content set;
Determining payment to be made by said advertiser for running said selected advertisement;
Notifying at least one publisher of said coupled content set for publication; and
Tracking the publication of the coupled content set by at least one of said publishers.

18. The method of claim 17 wherein reviewing criteria related to a selected advertisement comprises inputting keywords into a user interface, said keywords relating to the desired content.

19. The method of claim 17 wherein reviewing criteria related to a selected advertisement comprises intelligently searching previous usage of said selected advertisement and adopting keywords relating to said previous usage.

20. The method of claim 19 wherein said first search method comprises using said adopted keywords to search said content set.

21. The method of claim 20 wherein said second search method comprises intelligently evaluating a plurality of metrics selected from the group consisting of prices, previous usage, keywords, previous transactions for said selected advertisement and time to publication.

22. The method of claim 17 further comprising developing a search profile for said selected advertisement based on previous usage of said selected advertisement, said profile including criteria from said previous usage selected from the group consisting of prices, previous usage, keywords, previous transactions for said selected advertisement and time to publication.

23. The method of claim 22 wherein said second search method further comprises using an artificial intelligence method.

24. The method of claim 17 wherein determining payment to be made by said advertiser comprises initiating an auction and accepting bids for coupling said content items with said selected advertisement.

25. The method of claim 23 further comprising a Dutch auction.

26. The method of claim 17 wherein tracking the publication of the coupled content set by at least one publisher further comprises tracking the number of times the coupled content set has been downloaded.

27. The method of claim 17 further comprising selecting the media through which the coupled content set will be published.

28. The method of claim 27 wherein the media may be print, video, television and web.

29. The method of claim 17, wherein coupling the advertisement with the particular content further comprises previewing the advertisement coupled with the particular content.

30. The method of claim 17, further purchasing a selected content item by bidding for the content item through an auction server.

31. A network system comprising:
an advertisement providing means for storing advertisement information;
a content providing means in communication with the advertisement means for storing media content;
a distribution means for publishing the media content and advertisement information;
a database server means for processing and storing information provided by the content providing means; and
an artificial intelligence means for processing the information provided by the content providing means, the advertisement providing means, and the distribution means.

32. The network system of claim 31 further comprising a billing means in communication with the network, the billing server for tracking the publication of the coupled content set and arranging for payment of funds relative to the publication.
